(19) United States
(12) Patent Application Publication
(10) Pub. No.: US 2008/0064353 A1
(43) Pub. Date: Mar. 13, 2008

(54) METHOD AND APPARATUS FOR BASE STATION DIRECTED SELECTION OF A MULTIPLE ANTENNA CONFIGURATION

(75) Inventors: Sean M. McBeath, Keller, TX (US); Hao Bi, Lake Zurich, IL (US); John D. Reed, Arlington, TX (US); Jack A. Smith, Valley View, TX (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/668,616

(22) Filed: Jan. 30, 2007

Related U.S. Application Data
(60) Provisional application No. 60/824,826, filed on Sep. 7, 2006.

(51) Int. Cl. H04B 1/18

(52) U.S. Cl. 455/187.1

(57) ABSTRACT

A base station (214) and the mobile station (202) can arrange the multiple antenna configuration by receiving a base station parameter that is related to a preference for one of a plurality of multiple antenna configurations of the base station. The method includes sending the selected multiple antenna configuration to a base station so that the base station can designate and establish the multiple antenna configuration to be used for communications between the base station and the mobile station. If conditions change at either the base station or the mobile station, the present invention can adjust the selected multiple antenna configuration to accommodate the changed condition.

### FIELD OF THE INVENTION

The present invention relates generally to selecting a multiple antenna configurations and, in particular, using parameters received from a base station in the process of a mobile station selecting a multiple antenna configuration.

### BACKGROUND

3^{rd} Generation Protocol Partnership (3GPP) and 3GPP2 wireless communication systems, including, Universal Mobile Telecommunications System (UMTS), Evolved UMTS (E-UMTS) Terrestrial Radio Access (E-UTRA), and Evolved High Rate Packet Data (E-HRPD) systems are being developed and standardized by the wireless communication industry. E-UMTS and E-HRPD may employ Orthogonal Frequency Division Multiplexing (OFDM), while UMTS may employ orthogonal spreading codes such as Walsh codes. The mobile stations and base stations within these 3GPP and 3GPP2 systems can be supplied with multiple antennas. These multiple antennas can be arranged into various different configurations including a Space-Time Transmit Diversity (STTD) configuration, a Per Antenna Rate Control (PARC) configuration, a Single Stream Transmit Adaptive Array (TxAA) configuration, a Dual Stream Transmit Adaptive Array (DS-TxAA) configuration and other known and to be developed configurations. It is understood by those of skill in the art that the various configurations may require the use of one or more of the antennas supplied at each of the base station and the mobile station.

As the base station can operate in any of the plurality of multiple antenna configurations and the mobile station can operate in at least two of the plurality of multiple antenna configurations, a choice must be made as to the configuration to be used for transmitting and receiving, or tranceiving, signals over a link between the base station and the mobile station. It is understood that mobile stations and base stations may not be capable of operating in all available multiple antenna configurations. Each of the multiple antenna configurations has its strengths and weaknesses under given conditions. These given conditions can be taken from the perspective of the base station, the mobile station, the link between the base station and mobile station and the overall communication network, and each of the configurations performs differently under the given conditions. Since a selection is to be made, there is a need to consider the different conditions that exist.

According to the prior art, the mobile station can transmit its selected multiple antenna configuration to the base station. Such a solution presents issues including the absence of an adequate method for the mobile station to select the most appropriate multiple antenna configuration from among the plurality of available configurations. In addition, the mobile station makes a selection based on the limited information available at the mobile station. Thus, the mobile station does not take into consideration other information which may hinder the overall operation of the wireless communication system.

In view of the foregoing, there is a need to provide a method and apparatus that can select a multiple antenna configuration for a plurality of available multiple antennas according to a known and reliable process. In addition, the process needs to take into consideration parameters and preferences other than those known by the mobile station.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of a wireless communication network used in conjunction with some embodiments of the invention.

FIG. 2 is a block diagram of components within the wireless communication network incorporating the principles of the present invention.

FIG. 3 is a flow chart illustrating the operation of a mobile station incorporating the principles of the present invention.

FIG. 4 is a flow chart illustrating the operation of a base station incorporating the principles of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a base station directed selection of a multiple antenna configuration. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of a base station directed selection of a multiple antenna configuration as described herein. The non-processor circuits may include, but are not limited to, a radio receiver, a radio transmitter, signal drivers, clock circuits, power source circuits, and user input devices. As such, these functions may be interpreted as steps of a method to perform a base station directed selection of a multiple antenna configuration. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The present invention is directed to a wireless communication network that includes a base station and a mobile station where the base station includes at least two antennas and the mobile station includes at least one antenna. The multiple antennas can be arranged according to different configurations, schemes or modes where each of the configurations has given strengths and weaknesses under different conditions within the network, the base station and the mobile station. According to the principles of the present invention, the base station and the mobile station can arrange the multiple antenna configuration by receiving a base station parameter that is related to a preference for one of a plurality of multiple antenna configurations of the base station. In addition, the present invention includes selecting a multiple antenna configuration for use by the base station and the mobile station from the plurality of multiple antenna configurations using the base station parameter and a mobile station parameter. The method can include ordering each of the plurality of multiple antenna configurations such that the when selecting the multiple antenna configuration selection the configuration with the highest score is selected. In addition, the method can include sending the selected multiple antenna configuration to a base station so that the base station can designate and establish the multiple antenna configuration to be used for communications between the base station and the mobile station. If conditions change at either the base station or the mobile station, the present invention can adjust the selected multiple antenna configuration to accommodate the changed condition.

In an embodiment, the base station parameter can include at least one of a Quality of Service (QoS) requirement, a mobile station velocity requirement, a required feedback requirement, a throughput requirement and a channel rank requirement, where channel rank is a measure of the number of useful dimensions of the channel, including but not limited to the number of orthogonal branches. Each of these requirements takes into consideration the conditions on the link between the base station and mobile station that uses the multiple antenna configuration. The present invention can also include using a mode weighting factor or a mobile preference weighting factor with the various requirements to assist in prioritizing the different available multiple antenna configurations.

In an alternative embodiment of the present invention, a method is provided that determines a base station parameter that is related to the preference of a multiple antenna configuration used for transceiving signals between a base station and a mobile station. The base station parameter is sent and, in return, a multiple antenna configuration selection is received. The multiple configuration selection can be determined using the base station parameter and a mobile station parameter. A multiple antenna configuration is finally determined or designated by taking into consideration the received multiple antenna configuration selection. The determined multiple antenna configuration is then established between the base station and the mobile station.

In another embodiment of the present invention, a mobile station is provided that includes a multiple antennas, a transceiver and a controller that is coupled to the multiple antennas and the transceiver. The multiple antennas are combinable into a plurality of different multiple antenna configurations each using at least one of the multiple antennas. The transceiver is configured to transmit and receive signals with a base station in co-operation with the multiple antenna configuration. The controller selects a preference of a multiple antenna configuration to be used for transmitting and receiving signals between the mobile station and the base station. The selection is made using a base station parameter received from the base station together with a mobile station parameter. The transceiver can send the preference to the base station and receive the finalized determined configuration from the base station.

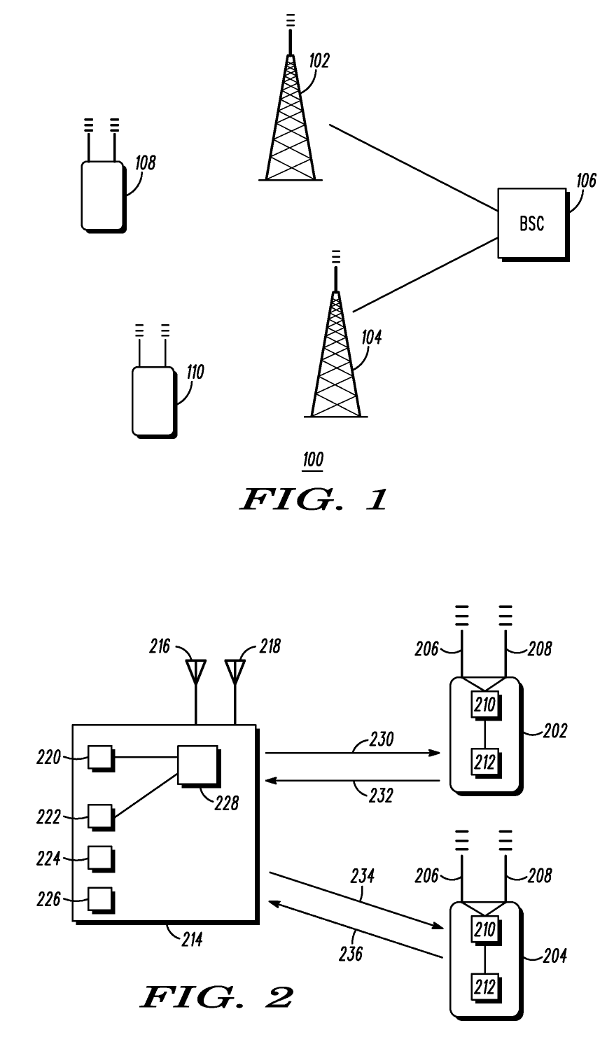

Turning to FIG. 1, a wireless communication network 100 is illustrated where the network 100 uses the principles of the present invention as described herein. In an embodiment of the invention, the wireless communication network is one of the 3GPP or 3GPP2 systems such as E-UMTS or H-HRPD. The wireless communication network includes a plurality of base stations 102, 104 that are known in the art and that operate according to the various requirements set for operation of the networks. Each of the base stations can be configured with a plurality of antennas, which are described in more detail below. The base stations 102, 104 are typically connected to a base station controller 106 that provides control information to the base stations in accordance with known methods so that the base stations operate according to the given requirements. The network also includes mobile stations 108, 110 that can be supplied with a plurality of antennas.

As is understood by those of skill in the art, the mobile stations 108, 110 can move throughout the network 100. As they move, a mobile station 108, 110 connects to a base station 102, 104 that provides wireless communication service to the area, known as a cell, in which that mobile station is located. When a mobile station connects to the base station, numerous different parameters must be set at both the mobile station and the base station in order to enable communication between these and other components within the network 100.

One such parameter is the configuration of the multiple antennas. Depending on the conditions found at the mobile station and the base station and the conditions within the wireless communication network 100, one of the various different configurations of the multiple antennas will provide a preferred performance of the components. The multiple antenna configurations can be arranged such that STTD, PARC, TxAA, DS-TxAA, and other configurations known and to be developed are used to provide communications between the base station and them mobile station. The selected multiple antenna configuration is determined during the establishment of the link between the base station and the mobile station and may change with time.

FIG. 2 is a detailed block diagram of the base station and mobile station that perform in accordance with the principles of the present invention. Mobile stations 202, 204 include a plurality of antennas 206, 208. While mobile stations 202, 204 are shown with two antennas, the principles of the present invention can be maintained when the mobile stations 202, 204 are provided with only one antenna or with more than two antennas. Regardless of the actual number, the antennas provided for each mobile station can be arranged into a multiple antenna configuration such as the STTD, PARC, TxAA and DS-TxAA configurations mentioned. The mobile stations are also provided with a transceiver 210 that is coupled to the antennas 206, 208 in a manner known such that the mobile station can transmit and receive signals. In addition, the mobile stations include a controller 212 that is coupled to the antennas 206, 208 and the transceiver such that the controller 212 selects the multiple antenna configuration and causes the transceiver 210 and the multiple antennas 206, 208 to operate in accordance with the designated antenna configuration.

Base station 214 is configured with a plurality of antennas 216, 218. Like the mobile stations 202, 204, the principles of the present invention can be maintained when the base station 214 is provided with only one antenna or with more than two antennas. Regardless of the actual number, the antennas 216, 218 provided for base station can be arranged into any of the multiple antenna configurations known. In particular, the base station can include a STTD processor 220, which operates the antennas 216, 218 in the known STTD mode, a PARC processor 222, which operates the antennas 216, 218 in the known PARC mode, a TxAA processor 224, which operates the antennas 216, 218 in the known TxAA mode, and a DS-TxAA processor 226, which operates the antennas 216, 218 in the known DS-TxAA mode. Additional processors can be provided to operate the antennas in different modes.

An antenna processing module 228 is coupled between the multiple antennas 216, 218 and the processors 220-226 so that the processors can operate and configure the multiple antennas into one of the different modes. The antenna processing module configures the antennas 216, 218 for each of the plurality of mobile stations 202, 204 that are communicating with the base station 214. When the base station 214 notices a new mobile station 202, 204 within its cell or mobile station 202 initiates communication with the base station 214, the antenna processing module 228 determines and establishes a multiple antenna configuration for that mobile station. The antenna processing module 228 is capable of determining and establishing multiple antenna configurations for the multiple mobile stations within the base station's cell, as is evident from the connections shown in FIG. 2. For example, antenna processing module 228 determines that that STTD is to be the multiple antenna configuration used by mobile station 202 and base station 214 and configures the multiple antennas 216, 218 according to requirements of STTD. Antenna processing module 228 also determines that PARC is to be the multiple antenna configuration used by mobile station 204 and base station 214 and configures the multiple antennas 216, 218 according to the principles of PARC. In an embodiment, the processors 220-226 operate the plurality of antennas in accordance with the procedures of the corresponding antenna mode. The multiple antennas for mobile stations 202, 204 can be configured according to the multiple antenna configuration determined by antenna processing module 228. As can be appreciated, mobile stations 202, 204 can also include an antenna processing module (not shown), which operates in a similar fashion with antennas 206, 208.

As a part of the present invention, the antenna processing module 228 can send scoring and preference parameters regarding the different multiple antenna configurations to the mobile stations 202, 204 as shown by downlinks 230, 234. The antenna processing module 228 can receive multiple antenna configuration selections from the mobile stations 202, 204 using uplinks 232, 236. Downlinks 230, 234 are used to provide the mobile stations 202, 204 with the multiple antenna configuration determined by the base station 214 to be used for the communications between the base station 214 and the mobile stations 202, 204.

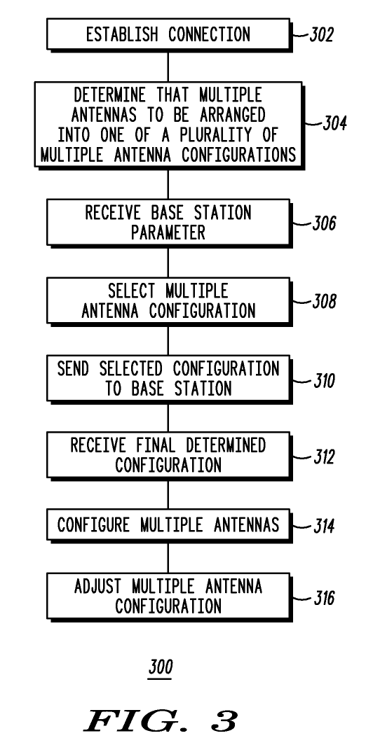

FIG. 3 is a flow chart of the operation 300 of a mobile station, for example mobile station 202, using the principles of the present invention. To begin, the mobile station 202 establishes 302 communications with a base station 214. The mobile station 202 can be entering into the cell served by base station 214 or can be initiating a call depending on the configuration of wireless communication network 100. When the connection between the mobile station 202 and base station 214 is established, it is determined 304 that the multiple antennas 206, 208 are able to be arranged into one of a plurality of different multiple antenna configurations. If the base station and mobile station cannot determine which configuration to use, the mobile station 202 uses a default configuration using one or more of the multiple antennas 206, 208.

If it is determined that the multiple antennas can be configured into a multiple antenna configuration, the mobile station receives 306 a base station parameter from the base station 214, and in particular from the antenna processing module 228. In an embodiment of the present invention, the base station parameter is a preference as to which of the different multiple antenna configurations, including but not limited to STTD, PARC, TxAA and DS-TxAA, the base station 214 determines from the conditions at the base station and network. The base station parameter can include an ordering or scoring of the different multiple antenna configurations. Alternatively, the base station parameter can be parameters of a function, where the function is based on a mobile station parameter. Parameters may be provided for each of the plurality of multiple antenna configurations. The mobile station 202 then selects 308 one of the various available multiple antenna configurations using the received base station parameter and a mobile station parameter. The mobile station parameter can take into account mobile station and network conditions known by the mobile station 202. Based on the base station parameter and the mobile station parameter, the mobile station orders the different multiple antenna configurations, the highest order configuration can be selected.

The mobile station sends 310 the selected multiple antenna configuration to the base station for processing. The base station then considers the mobile station's selected multiple configuration and determines, based on that information and the base station conditions and network conditions, the multiple antenna configuration to be used by the connection between the mobile station 202 and the base station 214. The final designated and determined multiple antenna configuration is then received 312 from the base station. The mobile station 202 then configures 314 at least one of the plurality of antennas 206, 208 in accordance with the designated multiple antenna configuration received from the baste station. As can be appreciated, the designated multiple antenna configuration will then be used for communications between the mobile station 202 and base station 214.

As is understood, the mobile station 202 can move from one cell to another cell or the conditions within a given cell may change. In an embodiment of the present invention, the designated multiple antenna configuration being used is adjusted 316 based on the changed conditions at the base station 214 and the mobile station 202. The designated multiple antenna configuration is adjusted using the process described above for establishing the original multiple antenna configuration.

As described above, the mobile station uses a base station parameter as a part of the selection process of the multiple antenna configuration. The base station parameter is a preference from among the different available multiple antenna configurations. In an embodiment, the base station parameter can be the result of a scoring function of the available antenna configurations that takes into account a variety of conditions and requirements including QoS requirements of the base station and mobile station, mobile station velocity requirements, required feedback requirements, throughput requirements and channel rank requirements. Other requirements based on additional conditions can be considered to determine the base station parameter.

The QoS requirement is used to ensure that the mobile station considers its desired data rate when choosing the selected multiple antenna configuration. The weight applied to each of the different multiple antenna configurations will vary as a function of the achievable data rate with respect to the desired data rate. For example, if the mobile station requires a 600 kbps link, and some of the different multiple antenna configurations are capable of providing 600 kbps, the additional weighting should be provided to those modes that can supply the data rates of at least 600 kbps. In an embodiment, the base station parameter can use a scoring metric of:

$$QoS = \frac{1}{1 + {e}^{- α ( acr - ddr )}}$$

where acr is the achievable data rate and ddr is the desired data rate and a is the base station parameter and may be different for the different multiple antenna configurations. The constant a can be signaled from the base station to the mobile station. In an embodiment, it is desired to have the acr higher than the ddr while, on balance, there is no gain in dedicating resources if a more simple multiple antenna configuration can be used at the desired rate.

A mobile velocity requirement can also be used as a part of base station parameter. Multiple antenna configurations work differently depending upon the velocity of the mobile station. Some configurations work poorly at high mobile station velocity since the antenna weights are unable to track changing channel conditions at the high velocities. For mobile velocity, a metric can be provided based on

MV=β(mobile_velocity)

where β is a function of the mobile station's velocity. The parameters of the function β are the base station parameter and may be different for different multiple antenna configurations. The mobile_velocity is the mobile station parameter. In an embodiment, MV can include a constant A where β and A are parameters of the configuration. The constants can be a part of a look-up table instead of a function. The mobile station knows the table and interpolates to find a score between 1 and −1 depending on the conditions of the mobile station at different velocities.

The required feedback requirement is based on those multiple antenna configurations that require feedback on the link between the mobile station and the base station. These configurations that require feedback can present reverse link or up link problems. In order to reduce the problems on the reverse or up link the required feedback requirement is considered as a part of the base station parameter. In an embodiment, multiple antenna configurations that require additional feedback receive a lower weighting in order to keep configurations reverse link at a minimum. For required feedback, a metric can be provided as:

FB=χ(num_bits)

where χ is a function of the number of bits required for feedback, and the number of bits may be different for different multiple antenna configurations. The function χ can be signaled from the base station to the mobile station and is used to reduce reverse link feedback in order to decrease interference. In this example, the parameters of the function χ and num_bits are the mobile station parameter. When the base station detects a high rise over thermal value, the base station can signal a new χ that more heavily favors the low feedback modes to some or all the mobile stations. In an example the function χ can range between 1 and −1 depending on the conditions.

Another condition that can be considered is the throughput of the link between the base station and the mobile station. If the operation of the base station often provides for a full buffer and large amount of data to be sent over the link, the multiple antenna configuration would benefit from a configuration with high throughput. In another embodiment, the base station parameter considers the channel rank, which is a measure of the ability of the channel to be divided into orthogonal branches for transmitting unique information per branch by the proper vector weighting of the signals associated with the transmit and receive antennas. If the channel rank is greater than 1, meaning that dividing the channel into orthogonal branches is possible, the channel rank can be considered as a factor in the selection process and weighted accordingly for antenna configurations that use orthogonal channels.

In an embodiment, a mode specific weighting function can be used by the base station as a part of determining the base station parameter. The mode specific weighting factor is used to prioritize the different multiple antenna configurations based network conditions and information on one or more mobile stations. The base station can signal to each of the mobile stations a specific mode specific weighting function for each of the different multiple antenna configurations. The weighting function can be used with the different requirements by the mobile station to determine a final score (S) for each of the multiple antenna configurations according to the following algorithm:

S=WF(QOS+MV+FB)

where WF is the weighting function, QoS is the QoS function provided above, MV is the mobile velocity function provided above and FB is the required feedback function provided above. Other factors, such as the channel rank and throughput requirements, can be added to the algorithm determining the base station parameter. S can be determined for each of the different multiple antenna configurations and provided to the antenna configuration with the highest S can be sent from the mobile station to the base station.

In another embodiment, specific base stations are designed to operate more efficiently in a designated multiple antenna configuration. Thus, a new mode specific weighting factor can be signaled when a mobile station engages with a base station that has given efficiencies with a given configuration. Network operators may wish to change mobile station operations in heavily loaded conditions or at busy hours to maximize coverage throughput over individual peak performance. Adjusting the weighting factors can achieve these results. In addition, if adjacent cells are heavily loaded, weighting factors can be used to avoid processing burdens in handoff conditions. The weighting factors can also be modified in response to QoS requirements when specific multiple antenna configurations are known to trade off average system throughput for individual peak data rates.

Similar to a mode specific weighting factor, a mobile preference weighting function can be used to further control the multiple antenna configuration selected by the mobile station. The mobile preference weighting factor has a value for each of the multiple antenna configurations. The mobile preference weighting factor can be transmitted to the mobile stations in response to given conditions. For example, a new mobile preference weighting factor can be signaled from the base station to the mobile station when the mobile station enters a specific location within a cell which is known to experience rapid signal changes, limited coverage or outages where one of the multiple antenna configurations is known to work well. Moreover, the mobile preference weighting factors can be used depending on the conditions of the mobile station such as low battery conditions to limit the selection of multiple antenna configurations requiring feedback.

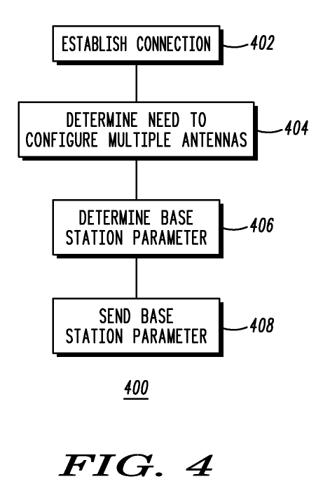

FIG. 4 illustrates another embodiment of the method of base station directed selection of a multiple antenna configuration for use by the base station 214 and mobile station 202. To begin, the base station 214 establishes 402 communications with the mobile station 202. This can occur when the mobile station 202 enters into the cell served by base station 214 or initiates a call. When the connection between the mobile station 202 and base station 214 is established, it is determined 404 that a multiple antennas configuration can be used for the multiple antennas found at both the base station and mobile station. If the base station and mobile station cannot determine which configuration to use, a default configuration is selected using one or more of the multiple antennas 216, 218.

When it is known that the multiple antennas at the base station and mobile station can be configured, the base station determines 406 a base station parameter. The base station considers conditions at the base station and in the network as a part of the determination. The base station 214, using the antenna processing module 228, can take into account the QoS requirement, the mobile velocity requirement, the required feedback requirement, the throughput requirement and the channel rank requirement. In addition, the antenna processing module 228 can use a mode weighting factor with the various requirements in order to provide the mobile station 202 with a base station parameter. In an embodiment, the base station parameter can be the base station's preference of the available multiple antenna configurations. In another embodiment, the base station parameter can include an ordering of available multiple antenna configurations or weighting factors for each of the multiple antenna configurations. In another embodiment, the base station parameter can be parameters of a function, where the function is based on a mobile station parameter.

After the base station parameter is determined, the base station 214 sends 408 the base station parameter to the mobile station. In response the mobile station 202 will use the base station parameter to select one of the plurality of multiple antenna configurations. In an embodiment, the mobile station 202 uses the base station parameter as a factor to be considered in selecting a multiple antenna configuration. A mobile station parameter can also be used by the mobile station 202. Furthermore, a mobile preference weighting factor can be used to weigh the different modes at the mobile station. The mobile weighting factor is similar to the mode weighting factor described above. The multiple antenna configuration selected by the mobile station is then sent by the mobile station and received 410 by the base station for further processing by the base station 214 and the antenna processing module 228. In an embodiment, an ordering or scoring of the different multiple antenna configuration is selected and sent to the base station as the selected multiple antenna configuration.

The antenna processing module 228, using the selected multiple antenna configuration, then determines or designates 412 the multiple antenna configuration to be used by the base station 214 and mobile station 202. The current network and base station conditions can be used during the determination. In an embodiment, the multiple antenna configuration selected by the mobile station 202 will be the final configuration determined by the base station 214. Alternatively, network and base station conditions may designate the base station to a multiple antenna configuration different from the one selected multiple antenna configuration received from the mobile station. Once the multiple antenna configuration is determined, the multiple antenna configuration is established and configured at the base station and the mobile station.

In an illustrative example, mobile station 202 establishes a connection with base station 214. Both the mobile station and the base station are arranged with multiple antennas, 206, 208, and 216, 218, respectively, and it is determined that the multiple antennas can be configured into multiple antenna configurations including STTD, PARC, TxAA and DS-TxAA. In this example, the mobile station is moving at a velocity of 120 km/hr and has desired data rate of 300 kbps. Using values of α, β, χ and WF that are specific to the network, base station and mobile station conditions present, the function described above are used to determine the various values shown in Table I below:

TABLE I

| Mode | QOS | FB | MV | WF | S |
|---|---|---|---|---|---|
| STTD | 0.6 | 0.25 | 0.5 | 1 | 1.35 |
| PARC | 0.7 | 0 | 0.5 | 0.8 | 0.96 |
| TxAA | 0.8 | −0.25 | −0.25 | 0.6 | 0.18 |
| DS-TxAA | 0.9 | −0.5 | −0.25 | 0.4 | 0.06 |

As seen, the determined S for each of the different multiple antenna configurations vary depending on the factors contributing to the base station parameter. The analysis of the values and the determination of S can provide a scoring of the different configurations. In an embodiment, all of the values of S are sent to the base station by the mobile station. Alternatively, a preference is made, typically using the highest value of S, and an indication of corresponding multiple antenna configuration is transmitted from the base station to the mobile station. In this embodiment, the selected antenna configuration corresponds to the STTD multiple antenna configuration as its value is highest. The mobile station then sends the selected multiple antenna configuration to the base station for final determination of the multiple antenna configuration to be used for the connection.

In another example, the mobile station is moving at a velocity of 3 km/hr and has desired data rate of 3,000 kbps. Using values of α, β, χ and WF that are specific to the network, base station and mobile station conditions present, the function described above are used to determine the various values shown in Table II below:

TABLE II

| Mode | QOS | FB | MV | WF | S |
|---|---|---|---|---|---|
| STTD | 0.01 | 0.25 | 0.5 | 1 | 0.76 |
| PARC | 0.9 | 0 | 0.5 | 0.8 | 1.12 |
| TxAA | 0.95 | −0.25 | 0.5 | 0.6 | 0.72 |
| DS-TxAA | 0.98 | −0.5 | 0.5 | 0.4 | 0.392 |

In this embodiment, the selected antenna configuration corresponds to the PARC multiple antenna configuration as its value is highest. The mobile station then sends the selected multiple antenna configuration to the base station for final determination of and designated the multiple antenna configuration to be used for the connection.

In yet another example, the mobile station is moving at a velocity of 10 km/hr and has desired data rate of 1,000 kbps. Using values of α, β, χ and WF that are specific to the network, base station and mobile station conditions present, the function described above are used to determine the various values shown in Table III below:

TABLE III

| Mode | QOS | FB | MV | WF | S |
|---|---|---|---|---|---|
| STTD | 0.01 | 0.25 | 0.5 | 1 | 0.76 |
| PARC | 0.02 | 0 | 0.5 | 1 | 0.52 |
| TxAA | 0.99 | −0.25 | 0.45 | 0.95 | 1.19 |
| DS-TxAA | 0.99 | −0.5 | 0.45 | 0.85 | 0.799 |

In this embodiment, the selected antenna configuration corresponds to the TxAA multiple antenna configuration as its value is highest. The mobile station then sends the selected multiple antenna configuration to the base station for final determination of the multiple antenna configuration to be used for the connection.

The different multiple antenna configurations perform different under varying conditions. The present invention uses an analysis of conditions at the base station to provide a base station parameter that can correspond to the preference of the base station as to one or more configurations. The analysis can use an algorithm as a function of the conditions to select from among the various multiple antenna configurations. The analysis allows the base station to have some control over which configuration the mobile station chooses. Without such control, the mobile station can choose its multiple antenna configuration based on limited information about the overall network 100 and the base station 214 by selecting a configuration that is optimum from its perspective, but one that may hinder overall system performance.

There may be more than one connection from the base to the mobile station, wherein each connection may support a different service, e.g. simultaneous voice and data connections. As such, there will likely be different antenna configurations selected for the each of the connections between base station and mobile station.

In other embodiments, it may be desirable to combine the two connections, resulting in a slightly higher combined data rate, and use a single antenna configuration to send the combined data using a single data connection with a single antenna configuration at one time. The data in such an embodiment could be reformatted into new data packets or kept separate.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method comprising:
receiving a base station parameter related to a preference of one of a plurality of multiple antenna configurations for a base station and a mobile station, and
selecting a multiple antenna configuration from the plurality of multiple antenna configurations using the base station parameter and a mobile station parameter.

2. The method of claim 1 wherein the base station parameter comprises at least one of a Quality of Service requirement, a mobile station velocity requirement, a required feedback requirement, a throughput requirement and a channel rank requirement.

3. The method of claim 2 wherein the Quality of Service Requirement is a function based on the achievable data rate and the desired data rate of a link between the base station and the mobile station using one of the plurality of multiple antenna configurations.

4. The method of claim 2 wherein selecting a multiple antenna configuration comprising using a mode weighting factor to prioritize one of the plurality of multiple antenna configurations.

5. The method of claim 2 wherein selecting a multiple antenna configuration comprising using a mobile preference weighting factor to prioritize one of the plurality of multiple antenna configuration.

6. The method of claim 1 further comprising:
ordering each of the plurality of multiple antenna configurations, and
wherein selecting a multiple antenna configuration comprises selecting the one of the plurality of multiple antenna configurations with a high order.

7. The method of claim 1 further comprising:
sending the selected multiple antenna configuration to a base station, and
receiving a designated multiple antenna configuration for use by the base station and the mobile station wherein the designated multiple antenna configuration considers the selected multiple antenna configuration.

8. The method of claim 1 further comprising:
adjusting the selected multiple antenna configuration based on changed conditions from among the conditions at one of the base station and the mobile station.

9. A mobile station comprising:
multiple antennas wherein the multiple antennas are combinable into a plurality of different multiple antenna configurations each having at least one of the multiple antennas;
a transceiver for transmitting and receiving signals with a base station wherein the transceiver is coupled to the multiple antennas, and
a controller coupled to the multiple antennas and the transceiver wherein the controller selects a preference of a multiple antenna configuration to be used for transmitting and receiving signals between the mobile station and a base station and wherein the controller selects the preference of a multiple antenna configuration using a base station parameter received from a base station and a mobile station parameter.

10. The mobile station of claim 9 wherein the base station parameter is based on at least one of a quality of service requirement, a mobile velocity requirement, a required feedback requirement and a channel rank requirement.

11. The mobile station of claim 9 wherein the controller further selects the preference based on a mobile weighting factor for the mobile station.

12. The mobile station of claim 9 wherein the controller further selects the preference based on a mode weighting factor specific each of the plurality of multiple antenna configurations.

13. The mobile station of claim 9 wherein the controller further causes the transceiver to send the preference of multiple antenna configuration to the base station.

14. The mobile station of claim 9 wherein the multiple antenna configuration include at least one of a space-time transmit diversity antenna configuration, a per antenna rate control antenna configuration, a single stream transmit adaptive array antenna configuration and a dual-stream transmit adaptive array antenna configuration.

15. A method comprising:
determining a base station parameter related to a preference of a multiple antenna configuration used for transceiving signals between a base station and a mobile station;
sending the base station parameter;
receiving a multiple antenna configuration selection determined using the base station parameter;
selecting the multiple antenna configuration wherein selecting considers the received multiple antenna selection, and
establishing the multiple antenna configuration.

16. The method of claim 15 wherein the base station parameter comprises one of a Quality of Service requirement, a mobile station velocity requirement, a required feedback requirement, a throughput requirement and a channel rank requirement.

17. The method of claim 16 wherein the Quality of Service requirement is a function based on the achievable data rate and the desired data rate of a link between the base station and the mobile station.

18. The method of claim 16 wherein the mobile velocity requirement is a function of a velocity of the mobile station and the capability of a link between the base station the mobile station to transceive signals at the velocity of the mobile station.

19. The method of claim 16 wherein the required feedback requirement is a function of whether a link between the base station and the mobile station requires feedback.

20. The method of claim 16 wherein the throughput requirement is a function of the level of throughput of signals transceived between the base station and the mobile station.

21. The method of claim 16 wherein the channel rank requirement is a function of the ability of a link between the base station and the mobile station to be divided into orthogonal pieces capable of transceiving signals.
